(19) United States
(12) Patent Application Publication
(10) Pub. No.: US 2003/0219059 A1
(43) Pub. Date: Nov. 27, 2003

(54) Thermographic system and method of operation thereof having composite implants

(76) Inventor: William R. Scott, Doylestown, PA (US)

Correspondence Address: NAVAL AIR WARFARE CENTER AIRCRAFT, DIVISION OFFICE OF COUNSEL BLDG 435, SUITE A, 47076 LILJENCRANTZ ROAD UNIT 7, PATUXENT RIVER, MD, 20670

(21) Appl. No.: 10/154,470

(22) Filed: May 23, 2002

(51) Int. Cl. G01N 25/72

(52) U.S. Cl. 374/5

(57) ABSTRACT

A system employing thermographic techniques is provided for inspecting materials and detecting defects therein such as void, inclusions, interlaminar disbonds, or porosity. The system utilizes a composite material and a source of pulsed current which is delivered to conductive elements within the composite material which, in turn, heats the material being inspected allowing thermographic techniques to be employed to measure the temperature distributions related to the application of the heat source and indicative of the defects of the material being measured.

### BACKGROUND OF THE INVENTION

1.0 Field of the Invention

The present invention relates to material inspection systems and methods of operation thereof, and more particularly, to a material inspection system that employs thermographic techniques to detect faults in the material manifested by temperature distributions on the surface of the material.

2.0 Description of the Prior Art

Inspection systems using thermographic techniques for the detection of defects in materials are known. The thermographic techniques require the use of a heat gun, a pulsed light source or other means of producing a thermal gradient across the material to be inspected. Because such heat sources are difficult to control and make uniform, and because the surfaces of many of the materials needing inspection are neither flat nor uniform in their heat absorbing properties, undesirable temperature gradients frequently arise at the surface of the materials being tested and such temperature gradients are sometimes not related to the material defects which makes the results of the inspection more difficult to interpret.

In addition to the above drawback, inspection systems employing thermographic techniques utilize a heat source, which is external to the material being tested. Because the distance which the heat source must travel before its effects are felt may be quite long, the use of such an external heat source limits the thickness of the material being inspected by these techniques.

It is desired that an inspection system and a method of operation thereof be provided using thermographic techniques that do not suffer the drawbacks of the conventional thermographic inspection system. More particularly, it is desired that a system be provided that eliminates the problems associated with the surface contour of the material being inspected, as well as reducing the limitation of the thickness of the material being inspected.

### OBJECTS OF THE INVENTION

It is a primary object of the present invention to provide for a material inspection system and a method of operation thereof that use thermographic techniques and which are not hindered by the surface contour of the material being inspected or the thickness of the material being inspected.

It is a further object of the present invention to provide for a system that is easily adapted to the material being inspected and does not add any inaccuracies to that inspection.

It is still a further object of the present invention to provide for measuring techniques that increase the sensitivity of the measurement being made which, accordingly, increases the sensitivity for detecting defects of the material being inspected.

The system for inspecting materials comprises a composite material, a network, a source of pulsed current, and instrumentation. The network is incorporated within the composite material being inspected at the time it is fabricated and the network is in intimate contact with the composite material and comprises at least one electrically conductive element having electrical connections. The source of the pulsed current is connected the at least one electrically conductive element. The instrumentation has the capability for remotely mapping temperature distributions on the surface.

### BRIEF DESCRIPTION OF THE DRAWINGS

Features and advantages of the invention, as well as the invention itself, will become better understood by reference to the following description when considered in conjunction with the accompanying drawings, wherein like reference numbers designate identical or corresponding parts thereof and wherein:

FIG. 1 is a block diagram of the inspection system of the present invention;

FIG. 2 is composed of FIGS. 2(A), 2(B), and 2(C) that respectively illustrate first, second and third layers and constitute an exploded view of a laminate related to the present invention.

FIGS. 3, 4, and 5, respectively illustrate alternative embodiments of composite material layers usable with the inspection system and having electrically conductors lodged therein.

### DETAILED DESCRIPTION OF THE PREFERRED EMBODIMENTS

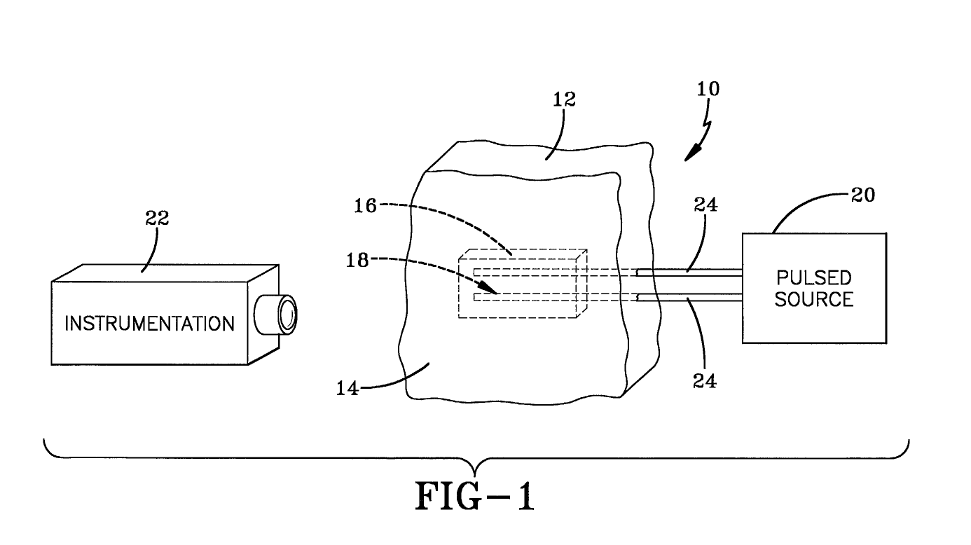

With reference to the drawing, FIG. 1 illustrates a block diagram of the system 10 of the present invention for inspecting laminated (or layered) materials 12 having a surface 14. The system detects defects within the material, such as voids, inclusions, lack of bonding between layers sometimes referred to as interlaminar disbonds or simply disbonds, and porosity. Interlaminar disbond is a term used to describe a region in a composite where one layer or lamina is not adhesively bonded to its adjacent layer. The system 10 comprises a composite material 16, a network 18, a source of pulsed current 20, and instrumentation 22. The source of pulsed current 20 is connected to the composite material 16 by way of electrical conductors 24 herein interchangeable referred to as “heater fibers.”

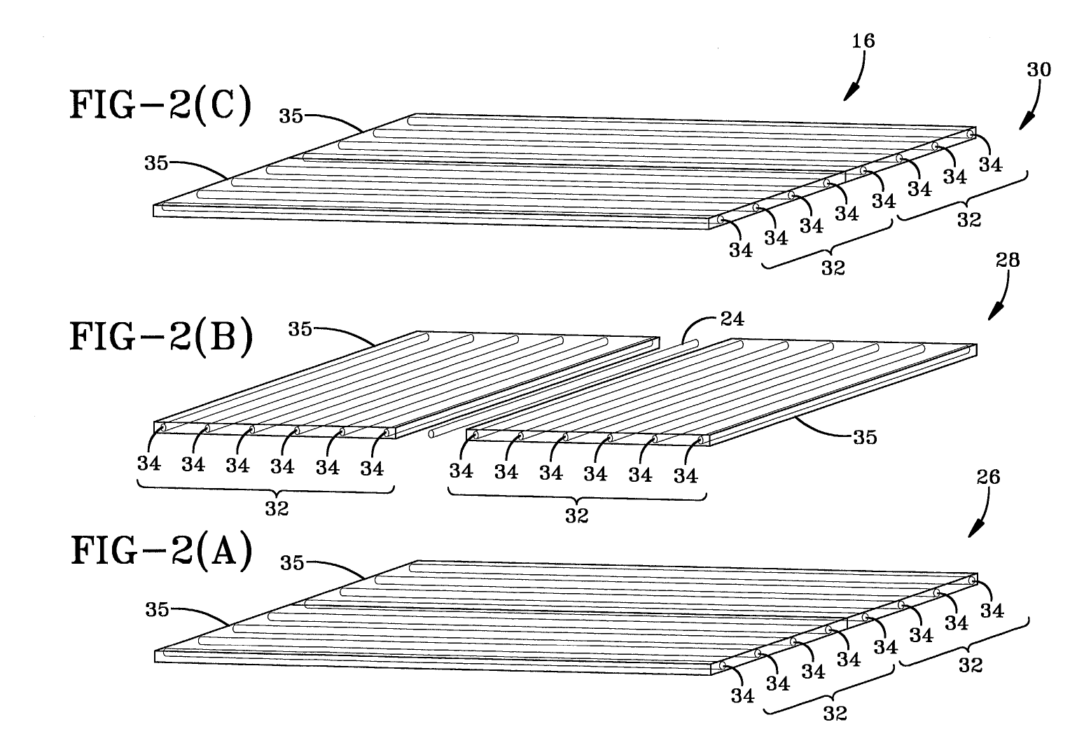

As used herein, a tape is a planar array of impregnated fibers laid side by side to form an arrangement similar to that of packing tape, that has glass fibers therein. The tape related to the present invention may be further described with reference to FIG. 2, which is composed of FIGS. 2A, 2B, and 2C that, respectively, illustrate a first edge-to-edge layer 26, a second edge-to-edge layer 28 and a third edge-to-edge layer 30 each comprised of tapes 32.

Each of the tapes 32 is comprised of a group of fibers 34 spaced apart from each other and laying in a matrix material 35. The matrix material 35 forms a slab and the dimensions and boundaries of the corresponding matrix material 35 define the dimensions and boundaries of the tapes 32.

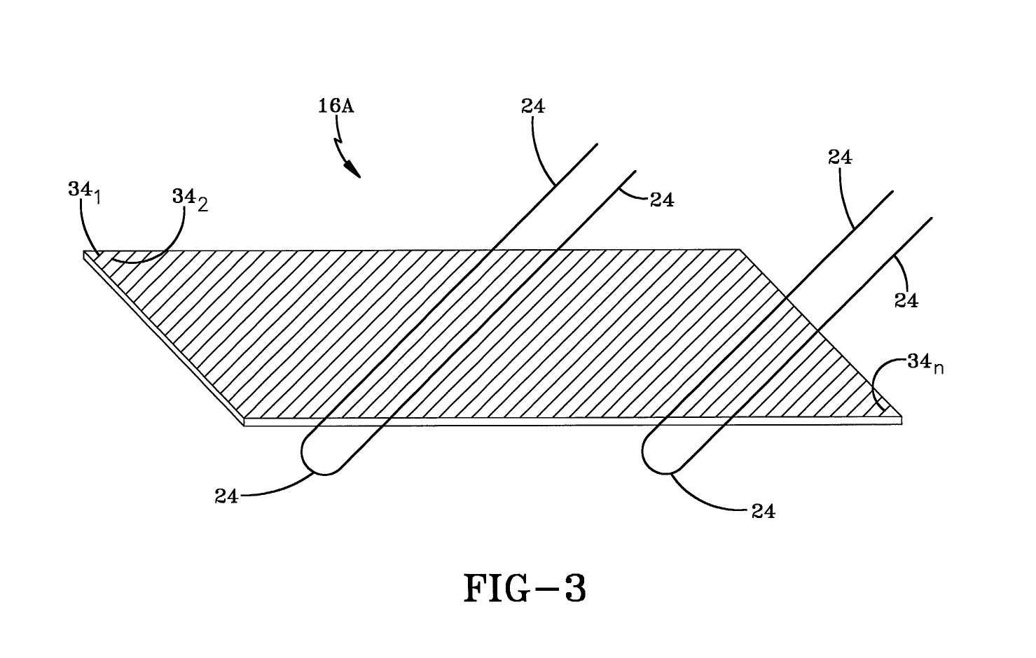

These tapes 32 used in the practice of the present invention are relatively long, relatively thin and are commonly several inches wide. Normally, several of these tapes are laid edge to edge to form a layer or lamina, such as shown in FIGS. 3-5 to be described. A composite laminate, as used herein, is composed of several of these edge-to-edge layers 26, 28, and 30 stacked on top of each other. Normally, the adjacent layers have their fibers oriented in different directions to produce a desired set of mechanical properties to be described hereinafter. By way of illustration, FIG. 2 shows a composite laminate 16 consisting of three layers 26, 28, and 30 with the first layer 26 comprising tapes formed of fibers 34 having their edges adjacent, the second layers comprising tapes formed of fibers 34 arranged perpendicular to the first layer 26 and the third layer 30 comprising tapes 32 formed of fibers arranged in a manner corresponding to that of the first layer 26. In this embodiment, the electrical conductors 24 may take the form of wires arranged between the tapes forming the second layer 28.

When viewed together, FIGS. 2(A), 2(B), and 2(C) constitute an exploded view of a laminate 16. The upper face of the layer 28 of FIG. 2(B) is actually bonded to the lower face of the layer 30 of FIG. 2(C). Similarly, the lower face of the layer 28 of FIG. 2(B) is actually bonded to the upper face of the layer 26 of FIG. 2(A). The horizontal edges of the two tapes 32 in FIGS. 2(A) and 2(C) in actuality are tightly butted and bonded together. The edges of the two tapes adjacent to the wire 24 in FIG. 2(B) are butted against the wire 24 and bonded to it. Most real laminates have many more than three layers 26, 28 and 30 and each layer is most likely composed of more than two tapes 32. Also, tapes 32 in actuality consist of many fibers 34, not just a few. In addition, many actual laminates 16 have twisted fiber bundles (like rope) therein.

The material 12 being inspected is typically a fiber reinforced composite material consisting of fibers embedded in a surrounding material (the matrix), while the material 16 is a layer of that composite 12 in which the electrically conducting heater fibers 24 are embedded. These heater fibers 24 comprise only a small fraction of the volume of the entire laminate of material 16 or in fact of the layer of material 16 in which they are placed. Ideally, with the exception of the inserted heater fibers 24 there is no difference between the materials 12 and 16. The inspection technique of the present invention may also be used with a variety of fiber reinforced materials 12 and 16 if desired. Possible matrix materials 35 present in 12 and 16 may be selected from the group including thermoset plastics, such as epoxy or phenolic or from a variety of thermo-plastics, such as polymide or polysulphone. The composite material 16 is placed in intimate contact with and is part of the material 12 being inspected. More particularly, the composite material 16 may be placed on either surface 14 of the material 12 being inspected or may be imbedded in the material 12 itself.

The network 18, in a manner similar to that of composite material 16, is placed in intimate contact with the material 12 being tested. More particularly, the network 18 may be placed on the surface of the composite material 16, but preferably is placed within the composite material 16 itself. The network 18 is comprised of at least one, but preferably a plurality of electrically conductive loops or complete circuits 24, each having two ends which are connected to the source 20 of pulsed current. The electrically conductive elements 24 are selected from the group consisting of electrically conductive fibers, and electrically conductive wires, which preferably carry an insulated coating thereon. These heater fibers 24 may be made from electrically conducting materials including graphite, and metallic wires. If a non-conducting reinforcing fiber and matrix are used, there is no need to insulate the heater fibers 24.

In one preferred embodiment, a D.C. source of current 20 is used and both ends of the electrical conductors 24 are connected thereto in order to have a completed circuit that permits current flow. In another embodiment, a radio frequency (RF) or higher frequency source may be used, but the results thereof are believed to be less desirable than the use of the D.C. source of current 20.

The heater fibers 24 are typically inserted into the composite material 16 at the time layup takes place, that is, during fabrication and prior to the actual inspection. Here, by the term layup it is meant the process of assembling fiber reinforced tapes to be made into a composite material. This is done either by placing the heater fibers 24 in between adjacent fiber reinforced tapes or using a modified tape with the heater fibers 24 included in it, a tape being a planar array of uni-directional reinforcing fibers impregnated with a matrix material. At the time of layup, the matrix making up the composite material 16 is frequently a soft viscous material and the layers making up the composite material 16 are flexible. The plastic resin regions (usually epoxy) within both materials 12 and 14 could be cured simultaneously by heating the material under pressure. The layer of the composite material 16 containing these heater fibers 24 then constitutes one layer or lamina in the composite laminate making up the composite material 16. There would probably be no reason for foreseeable applications to have more than one or two such layers in the laminate making up the composite material 16.

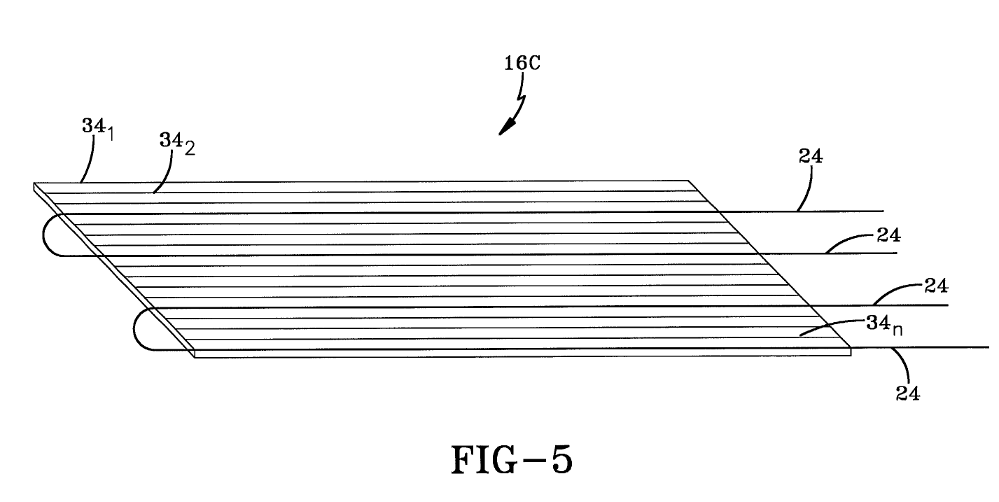

In one embodiment, the composite material 16 consists of reinforcing fibers having predetermined size and mechanical properties, whereas the electrically conductive elements 24 consist of electrically conductive graphite fibers having parameters selected to match the predetermined size and mechanical properties of the reinforcing fibers of the composite material 16. The fibers in composites 16, which in one embodiment may be graphite epoxy, can be on the order of several microns in diameter. These fibers may be grouped into fiber bundles that can have diameters on the order of a few thousandths of an inch. These fiber bundles may in turn be laid side by side and impregnated with adhesive. The resulting planar structure would be called a prepreg tape whose arrangement is to be further described hereinafter with reference to FIG. 5. By placing many layers of such prepreg tapes side by side over a mandrel and curing the adhesive, an arbitrarily thick structure can be built up that has the shape of the mandrel. This is termed herein as a layup process previously mentioned. The portion of the final material that is composed of the adhesive is called the matrix. The individual layers are referred to as laminae or laminas and the final material itself is called a laminate.

In the practice of the present invention, it is desired to replace some of the fiber bundles in the finished part with an insulated conducting material, such as insulated invar (known in the art) wire or some other insulated, electrically conducting wire having a coefficient of thermal expansion that is close to that of the reinforcing fiber and having the same average diameter as the fiber bundles. This may be done by incorporating such wire into the prepreg tape, but it would also be possible to place the wires between the prepreg tape edges during the layup process. By making the wire the same diameter as the fiber bundles, internal stresses and local deformations in the material are reduced. In most cases this would not degrade the strength and uniformity of the final material and the part made from it. Also, the presence of fibers that varied significantly from the bundle diameter would most likely weaken the material.

Because graphite fiber has a very low thermal coefficient of expansion, the use of the low thermal expansion coefficient alloy minimizes internal strains produced when temperature changes occur in the alloy material. Also, because most alloys have a high strain to failure, it is unlikely that internal electrical connections will be broken during normal material use.

Graphite fiber is also electrically conducting. The use of a graphite fiber bundle coated with an insulating material, such as, an epoxy is an alternative to the use of the alloy wire and will most likely produce an even better mechanical and size match.

The matching of the fibers to the composite material 16 eliminates any stresses that would otherwise result in the electrically conductive elements 24 being placed in the composite material 16. The elimination of the stresses, in turn, improves the strength of the material 12 itself.

The instrumentation 22 comprising a thermography camera operates very much like a TV camera. In use it works by focusing an infrared digital camera on the surface 14 to be inspected. This infrared camera is similar to certain types of night vision cameras that image body heat, for example. In general, as the surface of the imaged body becomes hotter, the infrared image becomes brighter. By digitally subtracting one infrared image from another a measure of the temperature change is obtained independent of the actual temperature distribution on the surface 14. This imaging technique does not necessarily need to give exact temperature readings since the present invention looks for a non-uniform temperature distribution caused by the presence of defects affecting the thermal conductivity of the composite material 12 being inspected.

It is preferred that the instrumentation 22 provide for thermography or double exposure holography that function in a manner like television cameras and film cameras respectively and not be placed in contact with the material 12 being inspected. Other instruments 22 that are placed in contact with the material 12 being inspected may also be used. The contacting instrumentation 22 may comprise thermocouple arrays, thermistor arrays, or strain gage arrays.

In one embodiment, a shutter may be used with a non-contacting instrument to image the material 12 for a given length of time and/or at a predetermined time after the application of the heat pulse from source 20. Such techniques are known in the thermographic art.

The instrumentation 22 measures the temperature distribution created by the source 20 of pulsed current that is delivered to the composite material 16 which, in turn, delivers a pulsed current to the material 12 being inspected. The composite material 16 has various embodiments, which may be further described with reference to FIGS. 2, 3, 4, and 5.

FIGS. 2, 3, 4, and 5, each illustrate different embodiments, but all of which are comprised of a laminated composite material 16. The embodiments of FIGS. 2-4 each illustrate a composite material 16 comprised of an impregnated tape consisting of multiple fibers 34₁, 34₂ . . . 34ₙ. The composite material 16 is preferably graphite fiber reinforced plastic comprised of laminated epoxy impregnated tapes, sometimes also referred to as prepregs or prepreg tapes and previously discussed with reference to FIG. 2. The impregnated tapes may be arranged in layers and/or as adjacent tape layers.

For the embodiments shown in FIGS. 3, 4, and 5, the electrically conductive elements 24 are selected from the group consisting of wires and fibers and the electrically conductive elements 24 are placed within the arranged impregnated tape.

FIG. 3 shows an embodiment 16A comprised of an epoxy impregnated tape containing fibers 34₁, 34₂, . . . 34ₙ having electrically conductive elements 24, each having a looped arrangement, in intimate contact with the epoxy impregnated tape containing fibers 34₁, 34₂, . . . 34ₙ. The elements 24 are shown with both ends emerging from the edges of the composite material to permit closed circuit electrical contact to be made.

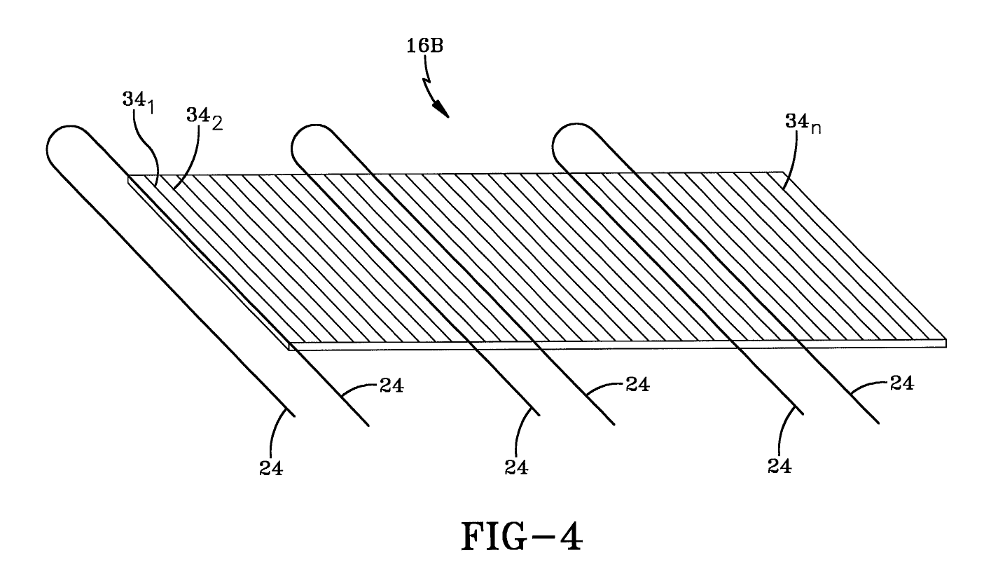

The embodiment 16B of FIG. 4 is quite similar to embodiment 16A of FIG. 2, except that the embodiment 16B has three electrically conductive elements 24, each having a looped arrangement, arranged in intimate contact with the epoxy impregnated tape containing fibers 34₁, 34₂, . . . 34ₙ. Similarly, FIG. 5, previously mentioned, illustrates another embodiment 16C having electrically conductive elements 24, each having a looped arrangement, arranged between adjacent epoxy impregnated tape containing fibers 34₁, 34₂, . . . 34ₙ.

In operation, and with reference to FIG. 1, the temperature measurement instrumentation 22 provides for mapping temperature distributions on the surface 14 and may be an instrument selected from the group consisting of thermographic and halographic cameras or thermocouple arrays, thermistor arrays, or strain gage arrays in a manner as previously described. Once the instrumentation 22 is arranged relative to the material 12 being inspected, the source 20 of pulsed current is energized which delivers current to the composite material 16 which, in turn, supplies current inside the material 12 being inspected. The electrically conductive members 24 are heated by passing a short duration of electric current from source 20 through the electrically conductive elements 24 in order to produce a pulse of heat that travels to the surface 14 of the material 12.

In operation, the temperature measurement instrumentation 22 observes the resulting change in temperature distribution on the surface 14 of the material 12 due to the production of heat created by the pulsing current, thereby, making it possible to detect defects or other abnormalities in the bulk of the material 12 that distorts the resulting pattern. The change in temperature can be observed by using the thermographic camera 22 or other devices capable of mapping temperature distributions. Alternatively, a holographic camera 22 can be used to monitor defect induced abnormalities in surface strain resulting from the thermal gradient within the material.

The holographic camera 22 is a device that uses single frequency laser light to make three dimensional film images of an object. If another laser light is used to properly illuminate the resulting film, a three-dimensional image of the object can be viewed with the eye. This process is sometimes termed image reconstruction. In material testing, such as performed by the present invention, a double exposure technique is sometimes used to monitor the deformation of components. If the object deforms uniformly between the first and second exposure (this might happen if a uniform temperature changes occurs), a series of uniformly spaced lines will appear in the final reconstruction of the three dimensional image. If, instead, a nonuniform deformation occurs (this might happen if a soldering iron were placed in contact with one point on the object), then highly curved rings or a bull's eye pattern, known in the art, would appear in the reconstructed image. In this way, the technique of the present invention for one embodiment thereof can be used to identify regions where non-uniform heating has occurred.

The practice of the present invention correlates temperature distributions with defects. As previously described, in one embodiment, composite materials 12 and 16 are built from layers of prepreg tapes. If proper fabrication takes place, each prepreg tape is tightly bonded to the one above and below it. However, if a problem occurs during the fabrication process of the material 12 being tested, or if a foreign material is inadvertently included between layers of the material 12 being tested, defects called delaminations may occur between the layers. These delaminations may adversely affect the strength of the material 12, especially under certain compressive and shear loads. The delamination is the most important type of defect found in laminated composite materials 12.

If a laminate making up the material 12 being tested is impacted heavily in a plane perpendicular to its layering, significant material 12 damage can occur including matrix cracks, fiber breaks and delaminations. A rosette pattern of these delaminations can be used to identify impact damage.

Typically, a delamination reduces thermal conduction between the layers on either side of it. If a source of heat is introduced above the delamination, this decrease of thermal conduction of the material 12 being tested will result in higher than expected temperatures above the delamination because the heat will not be able to dissipate as easily across it. Similarly, temperature will be lower than expected below it because it will take longer for the heat to reach it. As a result, when a damaged laminate of the material 12 being tested is heated in a uniform way, thermal anomalies will be present in an otherwise uniform temperature distribution.

In one preferred method of operation, the source of pulsed current 20 is repetitively energized and the temperature measurement instrumentation 22 records corresponding thermal images thereof. The temperature measurement instrumentation 22 may employ image averaging techniques for each of the images created in response to each of the repetitive cycles of the pulsed source 20 so as to increase the sensitivity of the inspection being performed. It may also employ image subtraction techniques to directly display the change in temperature distribution resulting from the heat pulse. It may in addition, employ shuttering techniques to sample the thermal distribution at a specific time after the application of the heat pulse from the source 20.

One of the advantages of the present invention is that the heat source lies within or is adjacent to the material 12 being inspected. The heat source, in the form of the electrically conductive elements 24, travels a short distance within the material allowing the inspection of thicker materials, relative to the thickness of material inspected by conventional thermographic material inspection systems.

It should now be appreciated that the practice of the present invention provides for inspection system and a method of operation thereof, that utilizes thermographic techniques for detecting defects in materials, such as voids, inclusion, interlaminar disbonds, or porosity.

It is understood that the invention is not limited to the specific embodiments herein illustrated and described and may be otherwise without departing from the spirit and scope of the invention.

What I claim is:

1. A system for inspecting materials having a surface, said system inspecting for defects in the materials and comprising:
a) a composite material placed in intimate contact with materials being inspected;
b) a network placed in intimate contact with said composite material and comprising at least one electrically conductive element having accessible electrical contacts;
c) a source of pulsed current connected to said electrical contacts of said electrically conductive element; and
d) instrumentation having the capability for mapping temperature distributions on said surface of said material being inspected.

2. The system according to claim 1, wherein said composite material is a material selected from the group consisting of laminated materials including graphite fiber reinforced plastics.

3. The system according to claim 1, wherein said electrically conductive element is selected from the group consisting of electrically conductive fibers and electrically conductive wires.

4. The system according to claim 3, wherein said electrically conductive wires carry an insulating coating.

5. The system according to claim 1, wherein said composite material is laminated.

6. The system according to claim 5, wherein said electrically conductive element is an electrically conductive fiber and is inserted in said laminated composite material.

7. The system according to claim 1, wherein said instrumentation for mapping temperature distribution on said surface is selected from the group consisting of a holographic camera, a thermographic camera, a thermocouple array, a thermistor array, and a strain gage array.

8. The system according to claim 1, wherein said composite material consists of reinforced fibers having a predetermined size and mechanical properties and said electrically conductive element consists of electrically conductive graphite fibers having parameters selected to substantially match said predetermined size and mechanical properties of said reinforcing fibers.

9. A method for inspecting materials having a surface, said method for detecting defects in the materials and comprising the steps of:
a) providing a composite material that is placed in intimate contact with the materials being inspected;
b) providing a network that is incorporated within said composite material and comprising at least one electrically conductive element having electrical contacts at each end;
c) providing a source of pulsed current which is connected to said conductive element with at least one electrically conductive element at both ends;
d) providing instrumentation having the capability for mapping temperature distributions on said surface;
e) energizing said source of pulsed current which is delivered to said electrically conductive element which, in turn, delivers the pulsed current to said composite material which, in turn, delivers the pulsed current inside said material being inspected; and
f) mapping the temperature distributions on said surface in response to said pulsed current to determine defects in said material being inspected.

10. The method according to claim 9, wherein said defects are represented by images indicative of defects of the group consisting of voids, inclusion, interlaminar disbonds, and porosity.

11. The method according to claim 9, wherein said instrumentation for mapping temperature distribution on said surface is selected from the group consisting of a holographic camera, a thermographic camera, a thermocouple array, a thermistor array and a strain gage array.

12. The method according to claim 10, wherein said source of current is energized on a repetitive basis and said instrumentation corresponding performs gated, synchronized image-averaging.

13. The method according to claim 10, wherein said source of current is energized on a repetitive basis and said instrumentation performs image subtraction.

14. The method according to claim 9, wherein said provided composite material consists of reinforcing fibers having a predetermined size and mechanical properties and said provided electrically conductive element consisting of electrically conductive graphite fibers having parameters selected to substantially match said predetermined size and mechanical properties of said reinforcing fibers.

15. The method according to claim 9, wherein said provided composite material is laminated.

16. The method according to claim 15, wherein said provided electrically conductive element is an electrically conductive fiber and is inserted in said laminated composite material.

17. The method according to claim 16, wherein said provided composite material is a graphite fiber reinforced plastic comprised of laminated epoxy impregnated tapes that are arranged from the group consisting of layers of tapes and adjacent tape layers.

18. The method according to claim 16, wherein said provided electrically conductive elements are selected from the group consisting of wires and fibers and said selected electrically conductive element is placed with said arranged tapes.
